(19) United States
(12) Patent Application Publication
(10) Pub. No.: US 2025/0013566 A1
(43) Pub. Date: Jan. 9, 2025

(54) ALLOCATION OF THREAD LOCAL STORAGE WHEN A THREAD SWITCHES BETWEEN LINK DOMAINS SHARING A COMMON ADDRESS SPACE

(71) Applicant: VMware LLC, Palo Alto, CA (US)

(72) Inventors: Aidan Cully, St. Augustine, FL (US); Dušan Veljko, Temerin (RS)

(21) Appl. No.: 18/763,532

(22) Filed: Jul. 3, 2024

Related U.S. Application Data
(60) Provisional application No. 63/512,239, filed on Jul. 6, 2023.

(51) Int. Cl. G06F 12/08; G06F 9/455

(52) U.S. Cl. CPC G06F 12/08; G06F 9/45558; G06F 2009/45583; G06F 2212/657

(57) ABSTRACT

Thread local storage is allocated to a thread that is executed in different link domains that share a memory address space by initially allocating a thread local storage having a first base address in the shared memory address space to the thread and a thread local storage having a second base address in the shared memory address space to a second thread that is created as a watcher thread of the first thread. When it is determined that the first thread has made a transition from executing code from the first link domain to executing code from the second link domain, the thread local storage having the second base address is allocated to the first thread. Thereafter, when it is determined that the first thread has resumed executing code from the first link domain, the thread local storage having the first base address is allocated to the first thread.

### CROSS-REFERENCE TO RELATED APPLICATION(S)

This application claims the benefit of U.S. Provisional Application No. 63/512,239, filed Jul. 6, 2023.

### BACKGROUND

Data volume is increasing due to artificial intelligence (AI) and machine learning (ML) applications. This increase in data volume requires a commensurate increase in compute power. However, microprocessors often cannot supply the needed compute power. Consequently, accelerator hardware, e.g., graphics processing units (GPUs), is taking over many of the compute tasks.

In U.S. patent application Ser. No. 17/493,741, filed Oct. 4, 2021, which is incorporated by reference herein in its entirety, an application with specialized workloads, e.g., AI and ML workloads, is co-executed between an initiator node and an acceptor node equipped with the accelerator hardware. Co-execution of the application relies on an application monitor that is established on each of the nodes to virtualize the processes of the application. System calls made by the virtualized process (hereinafter referred to as “virtual process”) are intercepted and handled by the application monitors (as described in U.S. patent application Ser. No. 17/493,783, filed Oct. 4, 2021, which is incorporated by reference herein in its entirety), because their execution may involve resources not present on the node on which they were made.

As a result, when executing a system call, a thread of the virtual process will switch from executing code of the virtual process, which have been compiled and linked into the virtual process link domain, to executing code of the application monitor, which has been complied and linked into the application monitor link domain. The switch is problematic with respect to thread local storage, which is allocated on a per-thread basis, because the same thread local storage is being used while executing code in two different contexts.

### SUMMARY

A “link domain” is an address space in which different code for an application resides. In the description of the embodiments given below, code for a virtual process resides in a virtual process link domain and code for an application monitor resides in an application monitor link domain. In addition, a “thread local storage” is unique storage allocated for each thread. Thus, different threads are allocated different “thread local storage.”

One or more embodiments provide a method of allocating thread local storage to a first thread having a second thread created as a watcher thread of the first thread, wherein the first thread executes code from first and second link domains sharing a memory address space. The method includes: initially allocating a thread local storage having a first base address in the shared memory address space to the first thread and a thread local storage having a second base address in the shared memory address space to the second thread; determining that the first thread has made a transition from executing code from the first link domain to executing code from the second link domain and, in response thereto, allocating the thread local storage having the second base address to the first thread; and determining that the first thread has resumed executing code from the first link domain and, in response thereto, allocating the thread local storage having the first base address to the first thread.

Further embodiments include a computer-readable medium containing instructions that, when executed by a computing device, cause the computing device to carry out one or more aspects of the above method, and a system comprising a memory and a processor configured to carry out one or more aspects of the above method.

### BRIEF DESCRIPTION OF THE DRAWINGS

FIG. 1 is a block diagram of user computers connected to a clustered container host system in which embodiments may be implemented.

FIG. 2A depicts an application that is co-executed between an initiator node and an acceptor node.

FIG. 2B depicts virtualization boundaries in the initiator node and acceptor node.

FIG. 3 is a diagram that depicts threads and their corresponding thread local storage.

FIG. 4 depicts a flow of operations that are carried out during the creation of a main thread for a virtualized process of the application and a corresponding watcher thread.

FIG. 5 depicts a flow of operations that are carried out during a system call that is made while the main thread is executing code in one link domain, and is intercepted and handled by code in another link domain.

FIG. 6 depicts a flow of operations that are carried out during the creation of a child thread and a corresponding watcher thread.

FIG. 7 depicts a flow of operations that are carried out upon death of a thread.

### DETAILED DESCRIPTION

Thread local storage is allocated to a thread that is executing code in different link domains that share a memory address space. In the embodiments, different thread local storage is allocated to the same thread depending on which link domain code the thread is executing. In this manner, values of variables that are stored in the thread local storage may be preserved even though the executed code switches between the different link domains.

In the embodiments, the thread that executes code in different link domains is a virtual process thread, and a watcher thread is created as a companion thread of the virtual process thread. The virtual process thread is created to execute code from a virtual process link domain and the watcher thread is created to execute code from an application monitor link domain. When the code executed by the virtual process thread switches from the virtual process link domain to the application monitor link domain, the thread local storage of this thread is switched from that initially allocated thereto to that initially allocated to the watcher thread. The watcher thread is also configured to detect the death of the virtual process thread. Upon detecting the death of the virtual process thread, the watcher thread cleans up resources of the application monitor link domain used by the virtual process thread, and thereafter issues a wake-up call to other threads that have been waiting for the virtual process thread to die.

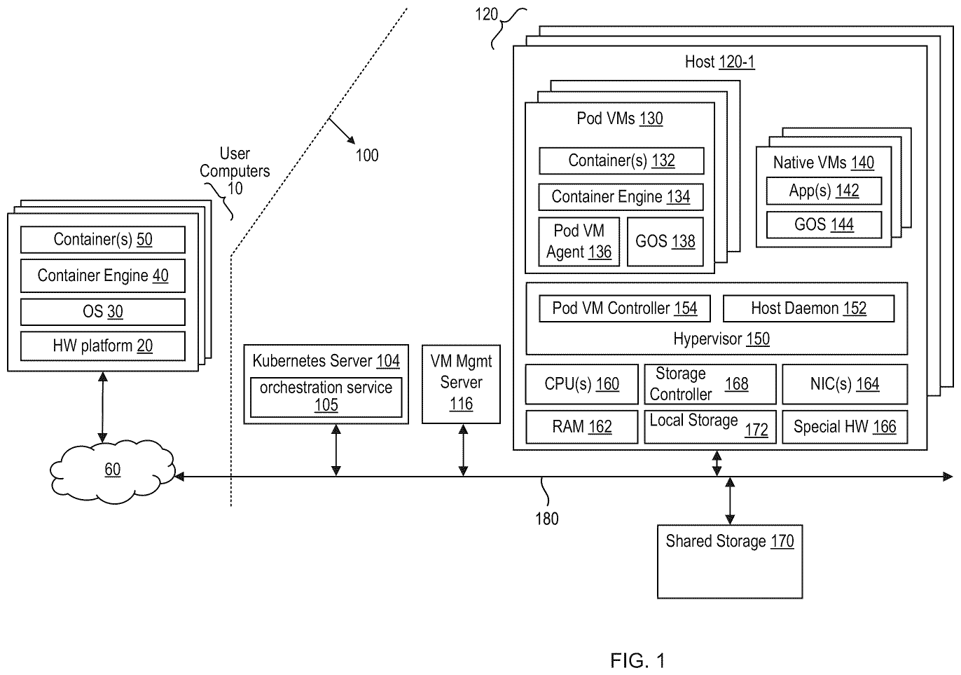

FIG. 1 is a block diagram of user computers 10 connected to a clustered container host system 100 in which embodiments may be implemented. As depicted, user computers 10 access clustered container host system 100 over a public network 60, e.g., the Internet. Clustered container host system 100 includes a cluster of hosts 120, which may be constructed on a server-grade hardware platform such as an x86 or ARM® architecture platform. The hardware platform includes one or more central processing units (CPUs) 160, system memory (e.g., random access memory (RAM) 162, one or more network interface controllers (NICs) 164, and special hardware 166, e.g., GPU or some other accelerator hardware. A virtualization software layer, also referred to herein as hypervisor 150, is installed on top of the hardware platform. The virtualization software layer supports a virtual machine execution space within which multiple VMs may be concurrently instantiated and executed. All hosts 120 are configured in a similar manner as host 120-1, and they are not separately described herein.

In the embodiment illustrated in FIG. 1, each host 120 accesses its local storage (e.g., hard disk drives or solid-state drives) 172 via its local storage controller 168 and accesses shared storage 170 through its NIC 164 and network 180. In another embodiment, each host 120 contains a host bus adapter (HBA) through which input/output operations (IOs) are sent to shared storage 170 through a storage area network (SAN). Shared storage 170 may comprise, e.g., magnetic disks or flash memory that is connected to network 180 or the SAN. In some embodiments, the local storage devices of hosts 120 may be aggregated and provisioned as a virtual SAN device that is accessed by hosts 120 as shared storage 170.

VM management server 116 is a physical or virtual server that provisions the VMs from the hardware resources of hosts 120. VM management server 116 logically groups hosts 120 into a cluster to provide cluster-level functions to hosts 120, such as load balancing across hosts 120 by performing VM migration between hosts 120, distributed power management, dynamic VM placement according to affinity and anti-affinity rules, and high availability. The number of hosts 120 in the cluster may be one or many.

In FIG. 1, a Kubernetes® system, which is implemented in the cluster of hosts 120, is depicted as an example of clustered container host system 100. In this system, Kubernetes server 104 is a virtual server (e.g., one of the VMs provisioned by VM management server 116) that communicates with pod VM controllers (e.g., pod VM controller 154 of host 120-1) installed in hosts 120 via network 180. In some embodiments, the Kubernetes server is distributed over the nodes, thus having no single point of failure. An application commonly known as kubectl runs on user computers 10, and an application administrator or developer (hereinafter referred to as the “user”) employs kubectl, and a configuration file (which contains the credentials to authenticate with the Kubernetes server) can issue commands to the Kubernetes server. For example, through kubectl, the user submits desired states of the Kubernetes system, e.g., as YAML documents, to Kubernetes server 104. In response, Kubernetes server 104 schedules pods onto (i.e., assigns them to) different hosts 120 (which are also nodes of a Kubernetes cluster in the embodiments). The pod VM controllers of the different hosts 120 periodically poll Kubernetes server 104 to see if any of the pods have been scheduled to the node (in this example, the host) under its management and execute tasks to bring the actual state of the pods to the desired state. In the embodiments, pods are implemented as pod VMs, which are further described below.

Hypervisor 150 of host 120-1 includes a host daemon 152 and a pod VM controller 154. Host daemon 152 communicates with VM management server 116 to instantiate VMs (both pod VMs 130 and native VMs 140). Each pod VM 130 includes a container engine 134 running on top of guest operating system (GOS) 138. In addition, a pod VM agent 136 of pod VM 130 communicates with pod VM controller 154 to spin up a set of containers 132 to run in or delete a set of containers 132 running in an execution space managed by container engine 134. Each native VM 140 is an ordinary VM (as distinguished from pod VMs), which includes a GOS 144 and applications (e.g., non-containerized applications) running on top of GOS 144.

The lifecycle of native VMs 140 is managed by VM management server 116 through host daemon 152. In contrast, the lifecycle of pod VMs 130 is managed by pod VM controller 154 according to the desired state communicated thereto by Kubernetes server 104. In the embodiments, in addition to managing the lifecycle of pod VMs 130, pod VM controller 154 also manages a work queue and determines when to suspend and resume pod VMs 130 according to entries in the work queue.

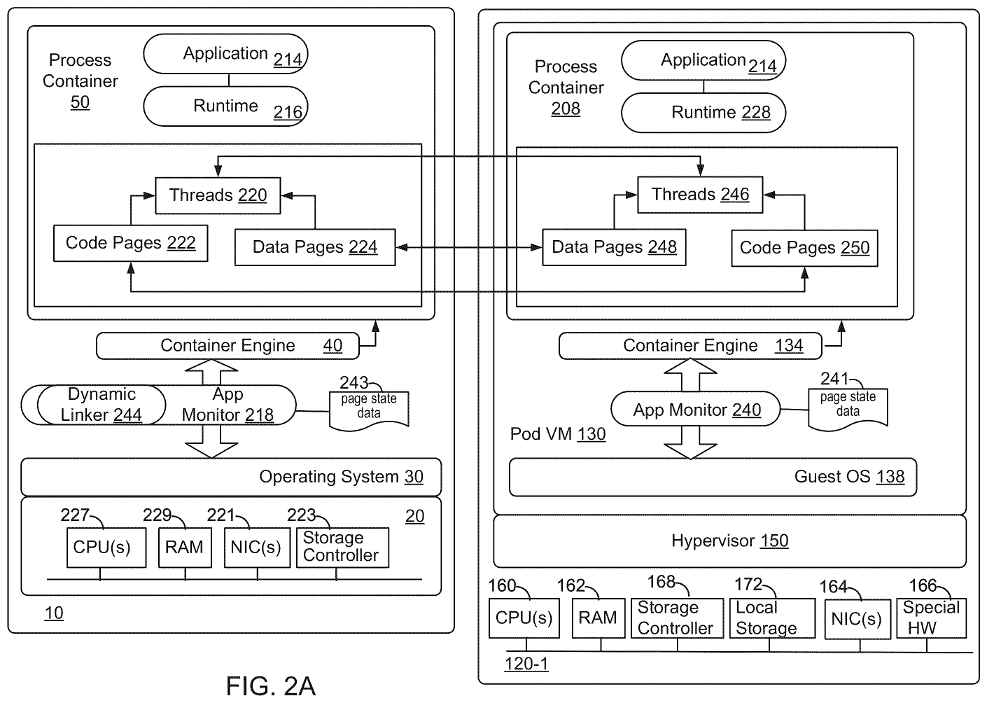

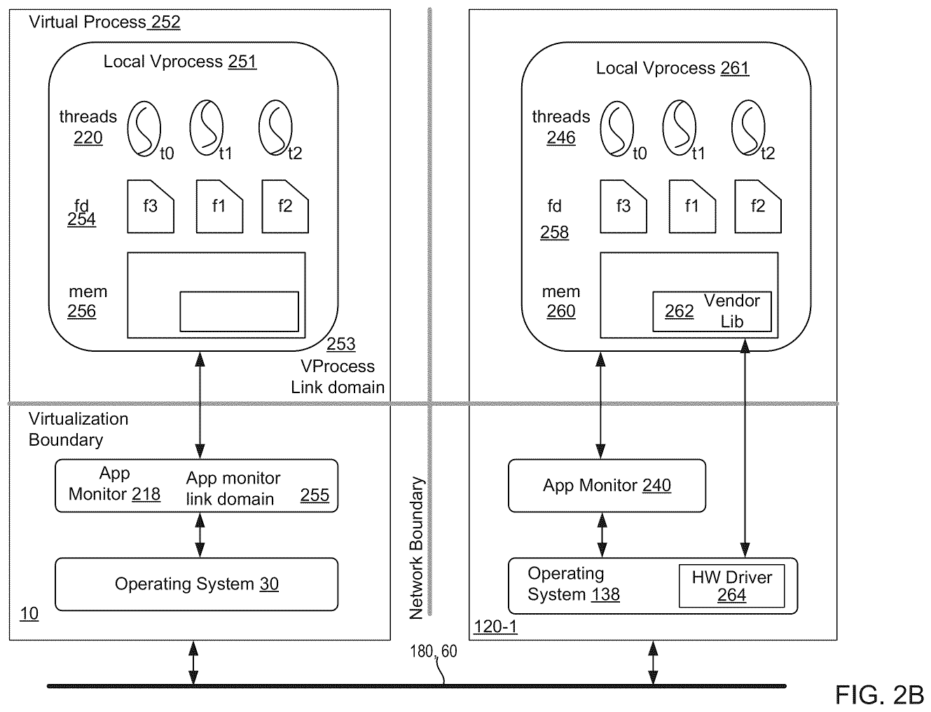

FIG. 2A depicts an application that is co-executed between an initiator node and an acceptor node. User computer 10 is an example of an initiator node, and hosts 120 are examples of acceptor nodes. In user computer 10, operating system 30 runs on top of hardware platform 20 of user computer 10, which includes one or more CPUs 227, system memory (e.g., RAM) 229, one or more NICs 221, and a storage controller 223 connected to local storage (not shown). Process container 50 is a container that runs in an execution space managed by container engine 40.

Application 214 is virtualized and co-executed by process container 50 running in the initiator node and process container 208 running in the acceptor node (one of hosts 120, depicted in FIG. 2A as host 120-1). The virtualization of application 214 into a virtual process is enabled by application monitors established in the nodes. In the embodiments depicted herein, process container 208 runs in the acceptor node and is a container that runs in an execution space managed by container engine 134 of pod VM 130. It is spun up in pod VM 130 of host 120-1 because host 120-1 is equipped with much higher processing power than the initiator node and special hardware 166 (e.g., GPU). The initiator node includes a runtime 216 and an application monitor 218, one or more threads of execution 220, code pages 222, and data pages 224. The acceptor node includes a runtime 228 and an application monitor 240, one or more threads of execution 246, code pages 250, and data pages 248.

Process containers 50, 208 typically run in a lightweight virtual machine or in a namespace provided by an operating system such as the Linux® operating system. In one embodiment, process containers 50, 208 are Docker® containers, runtimes 216, 228 are Python virtual machines, application 214 is a Python program with libraries such as TensorFlow or PyTorch, and threads of execution 220, 246 correspond to the threads of the Python virtual machine. The application monitor includes a dynamic linker (DL) 244. In general, a dynamic linker 244 is a part of the operating system that loads and links libraries and other modules as needed by an executable code while the code is being executed.

The two nodes are set up before co-executing application 214 between the initiator node and the acceptor node. Setup of the initiator node and the acceptor node includes establishing application monitors 218, 240 and runtimes 216, 228 on each of the nodes on which libraries or other deployable modules are to run, the coherent memory spaces in which the application, libraries, or other deployable modules are located, and the initial thread of execution of each runtime. The coherent memory spaces may be established in accordance with the techniques described in U.S. patent application Ser. No. 18/083,356, filed Dec. 16, 2022, the entire contents of which are incorporated by reference herein. After the setup is completed, in the course of executing the application on the initiator node, a library or other deployable module is executed on the acceptor node.

In setting up each node for co-execution of the application with the acceptor nodes, a virtualization boundary (described below with reference to FIG. 2B) is established by a bootstrap process that issues a Linux clone syscall to create a virtual process (hereinafter called VProcess), which shares an address space with the application monitor. The virtualization boundary separates the application monitor from VProcess. VProcess makes itself traceable by the application monitor via ptrace and issues itself a SIGSTOP. The application monitor then uses ptrace to intercept all system calls that VProcess issues. System call interception allows the application monitor to maintain the virtualization boundary for VProcess.

With the virtualization boundaries established, VProcess loads the application binary (i.e., the binary of the virtualized application) in the initiator node, with the ELF application binary mapped to the address space. The PT_INTERP section of the ELF application binary is read to locate the dynamic linker, which is then loaded into the address space. An initial stack, which contains program arguments, environment variables, including a variable that points to an agent library and a hook function pointer, and auxiliary vectors for VProcess, is assigned to the dynamic linker's entry code. The dynamic linker (e.g., dynamic linker 244) is then executed. Execution of the dynamic linker causes ELF symbol relocations, shared library loading, and maintaining of the program runtime all inside the virtualization boundary. Further details of the dynamic linker are described in U.S. patent application Ser. No. 17/493,781, filed Oct. 4, 2021, the entire contents of which are incorporated by reference herein.

FIG. 2B depicts in more detail virtualization boundaries in the initiator node and acceptor node. On the non-virtualized side of the virtualization boundary are the operating system and the application monitor, which enforces the virtualization boundary. On the virtualized side of the virtualization boundary is a single virtual process, VProcess 252, which includes a local virtual process, VProcess 251, on the initiator node and a virtual process, VProcess 261, on each acceptor node. The local virtual processes have access to various resources including threads of execution (t0, t1, t2), files (f0, f1, f2), and memory. The resources may be shared (usable from any node at any time), migratory (usable from any node but only one node at a time), or pinned (usable only from a certain node).

In the embodiments, different link domains that share the same address space are formed on either side of the virtualization boundary. The different link domains for the initiator node are depicted in FIG. 2B. They are VProcess link domain 253, which is the link domain into which code of the virtualized application is compiled and linked, and application monitor link domain 255, which is the link domain into which code of the application monitor is compiled and linked. Although not depicted, similar link domains are formed on either side of the virtualization boundary on the acceptor node.

Each local virtual process 251, 261 operates with one or more threads, and each such thread is allocated its own thread local storage. Each time a local virtual process creates a thread, it loads the base address of the thread local storage for that thread in a register of the processor executing the thread (hereinafter referred to as the “fs register”). In a similar manner, each application monitor operates with one or more threads, and each such thread is allocated its own thread local storage. Each time an application monitor creates a thread, it loads the base address of the thread local storage for that thread in the fs register. When threads are concurrently executed on two or more processors, the fs register in each of these processors contains the base address of the thread local storage of the thread executed thereon.

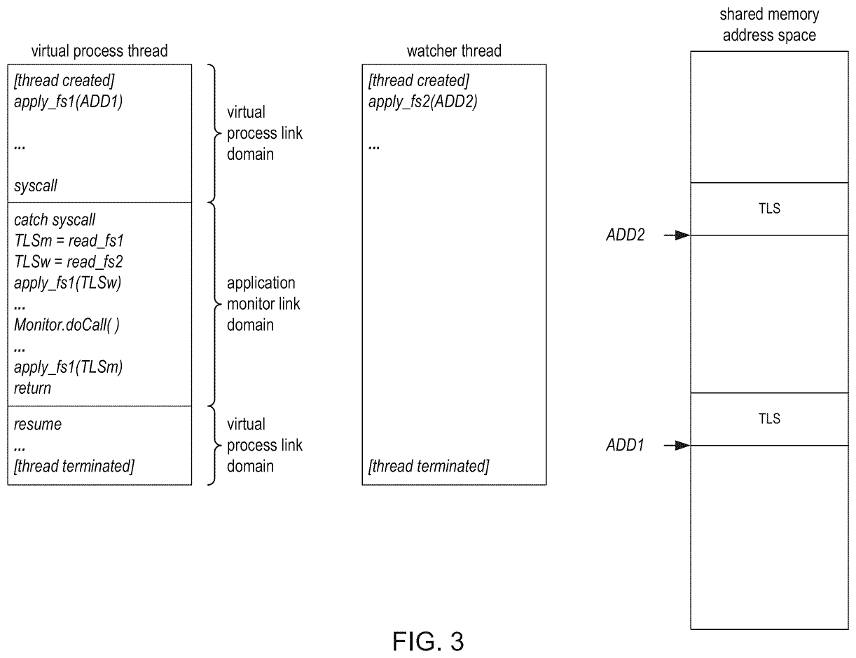

FIG. 3 is a diagram that depicts threads and their corresponding thread local storage. The threads depicted in FIG. 3 include a thread created by a virtual process and a watcher thread created by an application monitor. The virtual process thread is allocated thread local storage having a base address ADD1 in the shared memory address space and the watcher thread is allocated thread local storage having a base address ADD2 in the shared memory address space. It is assumed herein that the virtual process thread and the watcher thread execute in different processors and the base addresses of the thread local storage assigned to the two threads are stored in the fs register of the respective processor. The fs registers are referred to herein as fs register fs1 and fs register fs2. The watcher thread only executes in the application monitor link domain but the virtual process thread may execute in both the virtual process link domain and the application monitor link domain. As depicted in FIG. 3, a system call (syscall) executed by the virtual process thread is intercepted and thereafter the virtual process thread executes in the application monitor link domain to handle the system call. The handling of the system call is depicted in FIG. 3 by the function call, Monitor.doCall( ). The code executed by the virtual process thread in the application monitor link domain prior to handling the system call includes reads from two fs registers, fs1 and fs2. Register fs1 contains the base address of the thread local storage that was allocated to the virtual process thread upon creation. In the example of FIG. 3, this address is ADD1. Register fs2 contains the base address of the thread local storage that was allocated to the watcher thread upon creation. In the example of FIG. 3, this address is ADD2. After the reads from the fs registers, the value read from register fs2, TLSw, is stored in register fs1 when the thread calls the function “apply_fs1(TLSw).” Thereafter, the virtual process thread, while executing code in the application monitor link domain, uses the thread local storage of the watcher thread. When the virtual process thread returns to executing code in the virtual process link domain after the system call is handled in the application monitor link domain, the value read from register fs1, TLSm, is restored in register fs1 when the thread calls the function “apply_fs1(TLSm).”. Thereafter, the virtual process thread resumes executing code in the virtual process link domain, and while doing so, uses the thread local storage that it was originally allocated.

In the following description, the flow of operations within a single node is depicted. The single node may be the initiator node or one of the acceptor nodes and VProcess corresponds to the local virtual process running on that node (e.g., local VProcess 251 or local VProcess 252) and the application monitor corresponds to the application monitor running on that node to enforce the virtualization boundary of that node. In addition, references to a kernel in the description below are references to a kernel of operating system 30 when the single node is the initiator node and a kernel of guest operating system 138 when the single node is one of the acceptor nodes.

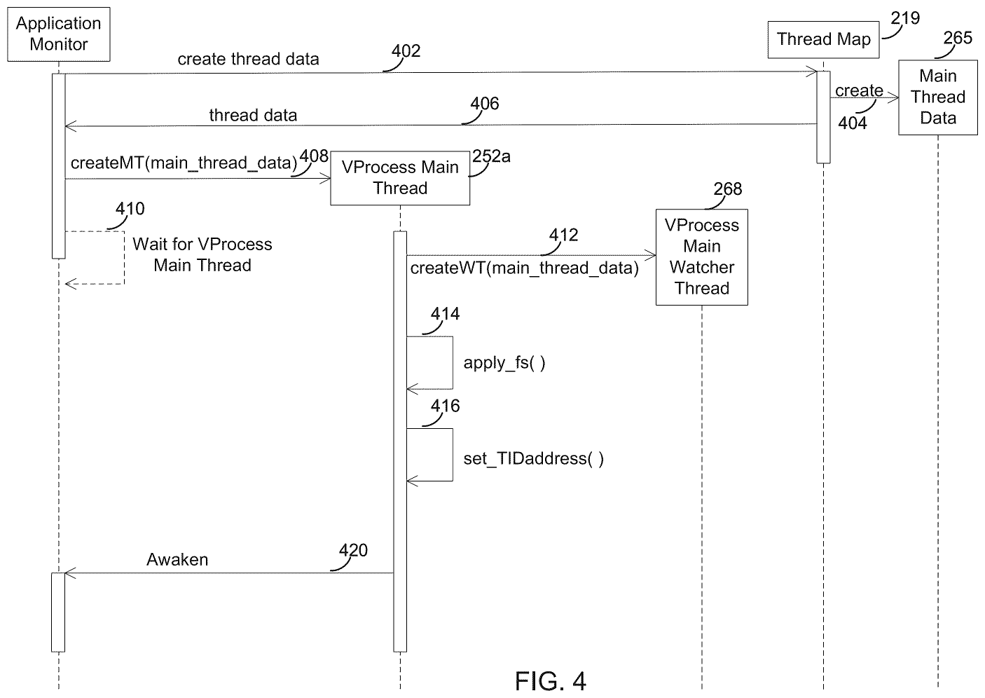

FIG. 4 depicts a flow of operations that are carried out during the creation of the main thread for VProcess, VProcess_Main_Thread, and a watcher thread for this main thread, VProcess_Main_Watcher_Thread. In step 402, the application monitor makes a request to create thread data for the main thread. In general, thread data for a thread contains specific information about the thread including its thread ID, base address of its thread local storage, and event notification address used for inter-thread communication referred to herein as TID address. In response, a thread map 219 in step 404 creates the thread data for the main thread (depicted as main thread data 265). Then, in step 406, thread map 219 returns main thread data 265 to the application monitor.

In step 408, the application monitor makes a request to create the main thread (createMT) with main thread data 265 as a parameter. The main thread, VProcess_Main_Thread 252a, is created in response to this request. In step 410, the application monitor waits for an awaken signal from VProcess_Main_Thread 252a, to give VProcess_Main_Thread 252a time to carry out its initialization process. The application monitor resumes executing when VProcess_Main_Thread 252a, after completing its initialization process, issues a awaken signal to the application monitor in step 420.

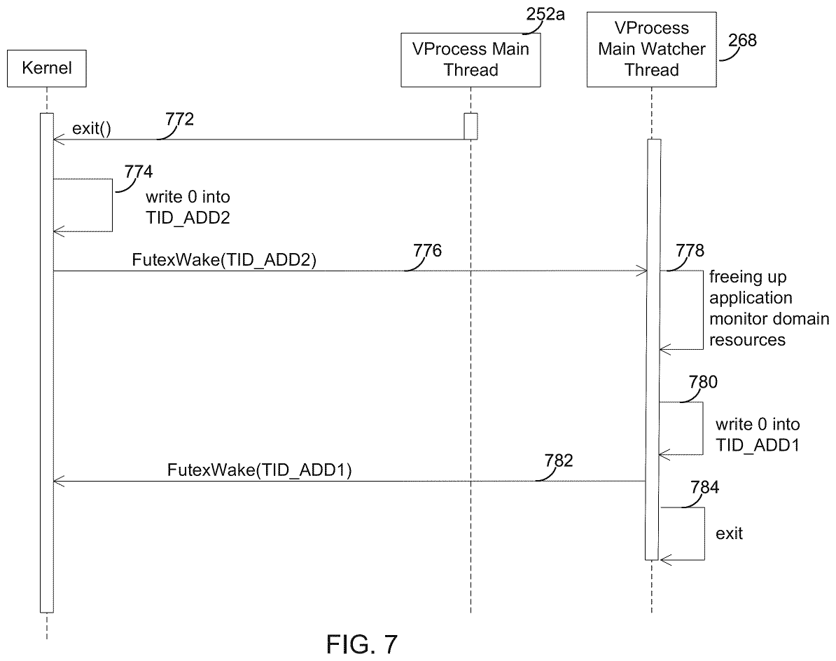

The initialization process of VProcess_Main_Thread 252a includes steps 412, 414, and 416. In step 412, VProcess_Main_Thread 252a makes a request to create a watcher thread (createWT) for VProcess_Main_Thread 252a with main thread data 265 as a parameter. The watcher thread, VProcess_Main_Watcher_Thread 268, is created in response to this request. The watcher thread is created so that VProcess_Main_Thread 252a can use the thread local storage of the watcher thread while it executes in the application monitor link domain. In step 414, VProcess_Main_Thread 252a calls the function apply_fs( ) to store the base address of the thread local storage that it has been allocated in the fs register of the processor that it is executing on. In step 416, VProcess_Main_Thread 252a calls a function to change its TID address, which is an event notification address in the shared memory address space that is used for inter-thread communication. When a thread dies (exits), the kernel writes a zero into this address and issues a wake-up operation known as FUTEX_WAKE against this address. The FUTEX_WAKE alerts other threads that are listening in on this address to check the value stored therein. The value of zero indicates to the other threads that the thread has died (exited). In the embodiments, the TID address of VProcess_Main_Thread 252a is changed from the one that it was assigned upon creation, referred to herein as TID_ADD1, to one that the watcher thread will observe, referred to herein as TID_ADD2. The effect of this change in the TID address of VProcess_Main_Thread 252a is described below in conjunction with FIG. 7.

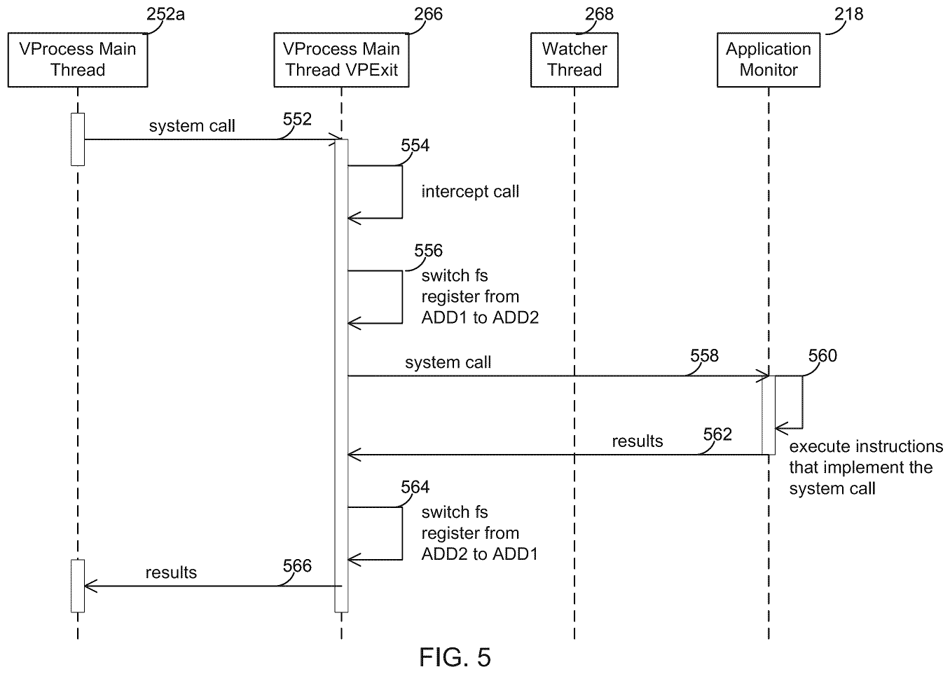

FIG. 5 depicts a flow of operations that are carried out during a system call from VProcess_Main_Thread 252a after VProcess_Main_Thread 252a has been initialized. In step 552, VProcess Main Thread 252a issues a system call and the system call is intercepted in step 554 by code of the application monitor that has been compiled into the application monitor link domain, referred to herein as VProcess_Main_Thread_VPExit 266. As a result, VProcess_Main_Thread 252a switches from executing in the virtual process link domain to the application monitor link domain, and the base address of the thread local storage for VProcess_Main_Thread 252a is switched in step 556 from ADD1, the one allocated to VProcess_Main_Thread 252a during initialization, to ADD2, the one allocated to its watcher thread, VProcess_Main_Watcher_Thread 268. The switch is performed by calling the function apply_fs( ) to store ADD2 in the fs register of the processor that VProcess_Main_Thread 252a is executing on.

After the switch in step 556, VProcess_Main_Thread_VPExit 266 makes the intercepted system call in step 558. In step 562, the application monitor examines the system call arguments, executes instructions as if the intercepted system call was executed, and returns the results to VProcess_Main_Thread_VPExit 266 in step 562. Then, before returning results to VProcess_Main_Thread 252a in step 566 and resuming execution in the virtual process link domain, the thread local storage for VProcess_Main_Thread 252a is switched back to ADD1 in step 564. The switch is performed by calling the function apply_fs( ) to store ADD1 in the fs register of the processor that VProcess_Main_Thread 252a is executing on.

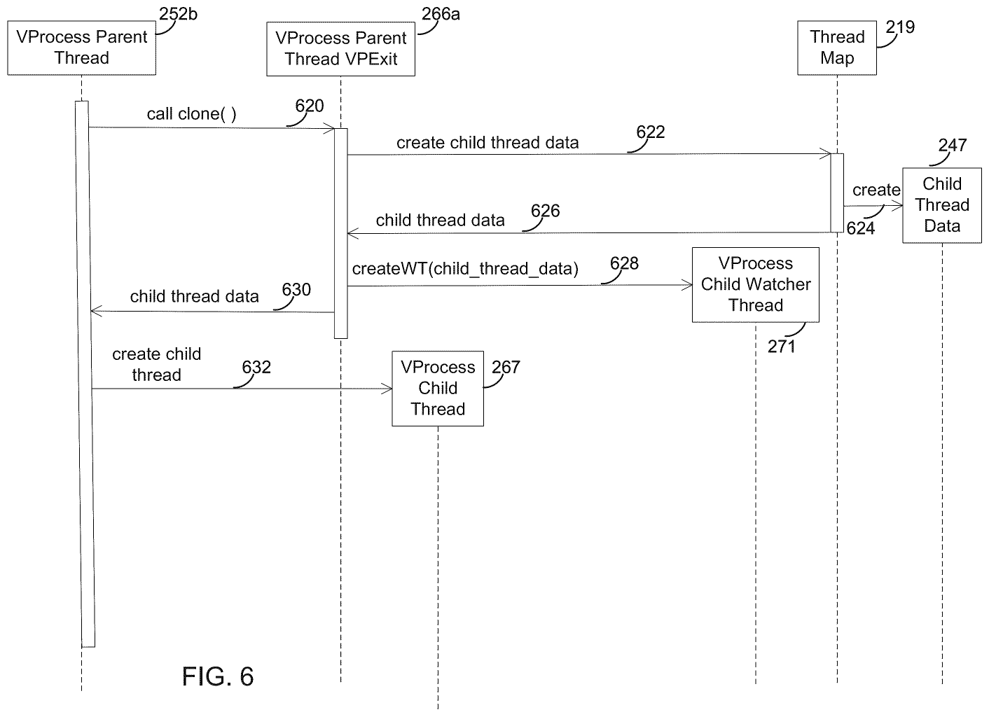

FIG. 6 depicts a flow of operations that are carried out during the creation of a child thread and a watcher thread for the child thread. The parent thread of the child thread may be VProcess_Main_Thread 252a or any other thread including a child thread for which another child thread is to be created. This parent thread is depicted in FIG. 6 as VProcess_Parent_Thread 252b. In step 620, VProcess_Parent_Thread 252b makes a system call to a clone function to create a child thread. The system call is handled intercepted and handled by code in the application monitor link domain as described above in conjunction with FIG. 5. This code is depicted in FIG. 6 as VProcess_Parent_Thread_VPExit 266a. In step 622, VProcess_Parent_Thread_VPExit 266a sends a request to thread map 219 to create child thread data. Thread map 219 creates child thread data 247 in step 624 and returns child thread data 247 to VProcess_Parent_Thread_VPExit 266a in step 626. In step 628, VProcess_Parent_Thread_VPExit 266a makes a request to create a watcher thread for the child thread with child thread data 247 as a parameter. In response, the child watcher thread is created and is depicted in FIG. 6 as VProcess_Child_Watcher_Thread 271. In step 630, VProcess_Parent_Thread_VPExit 266a returns child thread data 247 to VProcess_Parent_Thread 252b. Then, VProcess_Parent_Thread 252b makes a call to create the child thread in step 632. In response, the child thread is created and is depicted in FIG. 6 as VProcess_Child_Thread 267.

After creation of the child thread and the child watcher thread in the manner described above, whenever the child thread makes a system call while executing code in the virtual process link domain, the system call is intercepted by code in the application monitor link domain as described above for VProcess_Main_Thread 252a and the thread local storage is switched to that of the child watcher thread. As a result, while executing code in the application monitor link domain, the thread local storage of the child thread executing code in the virtual process link domain will be preserved and not be corrupted while executing code in the application monitor link domain.

FIG. 7 depicts a flow of operations that are carried out upon death of a thread. The example given herein is for the death of VProcess Main Thread 252a. In step 772, the kernel detects the death (exit) of VProcess Main Thread 252a. As a result, the kernel in step 774 writes a value of zero into the TID address of VProcess_Main_Thread 252a, which was changed as described above to TID_ADD2, and in step 776 issues a FUTEX_WAKE operation against this address. The FUTEX_WAKE operation issued against this address, TID_ADD2, wakes up threads that are listening in on this address, namely VProcess_Main_Watcher_Thread 268. Upon wake up, VProcess_Main_Watcher_Thread 268 reads the value stored at this address and, upon confirming that zero is stored at this address, performs step 778. In step 778, VProcess_Main_Watcher_Thread 268 frees up the application monitor link domain resources relating to VProcess Main Thread 252a. After performing step 778, VProcess_Main_Watcher_Thread 268 in step 780 writes a value of zero into the original TID address of VProcess_Main_Thread 252a, namely TID_ADD1, and issues a FUTEX_WAKE operation in step 782 to this address to inform all threads that are listening in on this original TID address of VProcess_Main_Thread 252a that VProcess_Main_Thread 252a has died (exited). Then, in step 784, VProcess_Main_Watcher_Thread 268 exits.

In the embodiments described above, scheduling and execution of workloads are implemented in a Kubernetes system. It should be understood that other implementations that do not employ Kubernetes are possible. In these other implementations, accelerator or any other special hardware is assigned to nodes of a multi-node system. The nodes can be VMs or physical machines running a conventional operating system, and each node has a service that reports to a manager service (running on one of the nodes) what accelerator hardware is available and how well they are utilized at any given moment. In these implementations, the manager service is responsible for selecting an acceptor node from one of the nodes of the multi-node system in accordance with the requirements of the initiator node and instructs a scheduler service running on the acceptor node to deploy an acceptor container (e.g., process container 208).

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data which can thereafter be input to a computer system. Computer-readable media may be based on any existing or subsequently developed technology that embodies computer programs in a manner that enables a computer to read the programs. Examples of computer-readable media including non-transitory computer-readable media are hard drives, NAS systems, read-only memory (ROM), RAM, compact disks (CDs), digital versatile disks (DVDs), magnetic tapes, and other optical and non-optical data storage devices. A computer-readable medium can also be distributed over a network-coupled computer system so that the computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of allocating thread local storage to a first thread having a second thread created as a watcher thread of the first thread, wherein the first thread executes code from first and second link domains sharing a memory address space, said method comprising:
initially allocating a thread local storage having a first base address in the shared memory address space to the first thread and a thread local storage having a second base address in the shared memory address space to the second thread;
determining that the first thread has made a transition from executing code from the first link domain to executing code from the second link domain and, in response thereto, allocating the thread local storage having the second base address to the first thread; and
determining that the first thread has resumed executing code from the first link domain and, in response thereto, allocating the thread local storage having the first base address to the first thread.

2. The method of claim 1, wherein the first link domain comprises code of a virtual process and the second link domain comprises code of an application monitor that is configured to create threads of the virtual process.

3. The method of claim 2, wherein the first thread is one of the threads of the virtual process.

4. The method of claim 3, wherein the virtual process is co-executed in two or more nodes, each of which includes the two link domains, a first of which comprises code of the virtual process and a second of which comprises code of the application monitor.

5. The method of claim 2, wherein
the first thread includes a system call and the application monitor is configured to intercept and handle the system call, and
the transition from executing code from the first link domain to executing code from the second link domain occurs as a result of the system call, and the resumption of executing code from the first link domain occurs as a result of a return from the system call.

6. The method of claim 5, wherein
the virtual process is co-executed in first and second nodes and first and second threads are executed in the first node, and
the system call is made to access resources residing in the second node.

7. The method of claim 1, wherein the first thread is initially assigned a first event notification address that other threads listen in on to determine if the first thread has died, and then assigned a second event notification address that the watcher thread listens in on to determine if the first thread has died.

8. The method of claim 7, further comprising:
upon receiving notification to wake up, determining a value stored at the second event notification address;
upon determining that the stored value is a first value, freeing up resources of the application link domain used by the first thread;
storing the first value at the first event notification address; and
issuing a wake-up operation against the first event notification address.

9. A non-transitory computer-readable medium comprising instructions to be executed in a processor of a computer system to carry out a method of allocating thread local storage to a first thread having a second thread created as a watcher thread of the first thread, wherein the first thread executes code from first and second link domains sharing a memory address space, the method comprising:
initially allocating a thread local storage having a first base address in the shared memory address space to the first thread and a thread local storage having a second base address in the shared memory address space to the second thread;
determining that the first thread has made a transition from executing code from the first link domain to executing code from the second link domain and, in response thereto, allocating the thread local storage having the second base address to the first thread; and
determining that the first thread has resumed executing code from the first link domain and, in response thereto, allocating the thread local storage having the first base address to the first thread.

10. The non-transitory computer-readable medium of claim 9, wherein the first link domain comprises code of a virtual process and the second link domain comprises code of an application monitor that is configured to create threads of the virtual process.

11. The non-transitory computer-readable medium of claim 10, wherein the first thread is one of the threads of the virtual process.

12. The non-transitory computer-readable medium of claim 11, wherein the virtual process is co-executed in two or more nodes, each of which includes the two link domains, a first of which comprises code of the virtual process and a second of which comprises code of the application monitor.

13. The non-transitory computer-readable medium of claim 10, wherein
the first thread includes a system call and the application monitor is configured to intercept and handle the system call, and
the transition from executing code from the first link domain to executing code from the second link domain occurs as a result of the system call, and the resumption of executing code from the first link domain occurs as a result of a return from the system call.

14. The non-transitory computer-readable medium of claim 13, wherein
the virtual process is co-executed in first and second nodes and first and second threads are executed in the first node, and
the system call is made to access resources residing in the second node.

15. The non-transitory computer-readable medium of claim 9, wherein the first thread is initially assigned a first event notification address that other threads listen in on to determine if the first thread has died, and then assigned a second event notification address that the watcher thread listens in on to determine if the first thread has died.

16. The non-transitory computer-readable medium of claim 15, wherein the method further comprises:
upon receiving notification to wake up, determining a value stored at the second event notification address;
upon determining that the stored value is a first value, freeing up resources of the application link domain used by the first thread;
storing the first value at the first event notification address; and
issuing a wake-up operation against the first event notification address.

17. A computer system configured to co-execute an application across a plurality of compute nodes that includes at least a first node and a second node, wherein each of the compute nodes comprise:
a plurality of processors; and
a system memory that stores code executed by the processors, wherein
code executed by the processors carries out a method of allocating thread local storage to a first thread having a second thread created as a watcher thread of the first thread, and the first thread executes code from first and second link domains sharing a memory address space configured in the system memory, said method comprising:
initially allocating a thread local storage having a first base address in the shared memory address space to the first thread and a thread local storage having a second base address in the shared memory address space to the second thread;
determining that the first thread has made a transition from executing code from the first link domain to executing code from the second link domain and, in response thereto, allocating the thread local storage having the second base address to the first thread; and
determining that the first thread has resumed executing code from the first link domain and, in response thereto, allocating the thread local storage having the first base address to the first thread.

18. The computer system of claim 17, wherein the first link domain comprises code of a virtual process and the second link domain comprises code of an application monitor that is configured to create threads of the virtual process, and the first thread is one of the threads of the virtual process.

19. The computer system of claim 18, wherein
the first thread includes a system call and the application monitor is configured to intercept and handle the system call, and
the transition from executing code from the first link domain to executing code from the second link domain occurs as a result of the system call, and the resumption of executing code from the first link domain occurs as a result of a return from the system call.

20. The computer system of claim 19, wherein
the virtual process is co-executed in the first and second nodes and first and second threads are executed in the first node, and
the system call is made to access resources residing in the second node.
